(19) United States
(12) Patent Application Publication
(10) Pub. No.: US 2005/0016152 A1
(43) Pub. Date: Jan. 27, 2005

(54) Crop picking system

(76) Inventor: Michael William Schwarz, Cambridge (NZ)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/624,949

(22) Filed: Jul. 23, 2003

(51) Int. Cl. A01D 45/00

(52) U.S. Cl. 56/327.2

(57) ABSTRACT

A mechanical picker for use in collecting asparagus spears, including a picking assembly, and a picking assembly carriage, characterised in that once the spear of asparagus has been selected to be picked, the picking assembly carriage continues to move forward with respect to the ground and the picking assembly moves backwards with respect to the picking assembly carriage so as to stay in a virtually static position during the picking operation with respect to the spear of asparagus that has been selected to be picked.

### TECHNICAL FIELD

This invention relates to a crop picking system.

In particular, this invention relates to a mechanical crop picking system to be used in the picking of asparagus spears.

Reference throughout this specification shall now be made to use of the present invention in relation to the picking of asparagus spears.

However, this should not be seen to be a limitation on the present invention in any way as the present invention may be used to pick other types of crop that forms a stem that needs to be severed.

### BACKGROUND ART

Various manual methods of picking asparagus spears are well known within the industry. These generally consist of pickers using long handles with a knife, or other form of blade, affixed to one end in order to limit the amount of bending needed by the asparagus picker.

The picking of asparagus spears has to be done regularly in order to ensure that the crop is at its optimum quality as it is a fast growing crop.

Currently all asparagus is picked manually and it is a very labour intensive industry.

The manual collection of asparagus spears has many disadvantages associated with it.

One big disadvantage is that if you cannot get enough pickers at the correct time, the crop can be spoiled or downgraded and therefore the asparagus grower can get significantly reduced revenue for their crop.

In some climates the asparagus spears need to be cropped twice a day in order to keep the crop at its optimum quality. The spears have an optimum height above which they are downgraded as the tip starts to open and then “leaf break” occurs.

This will entail using each team of pickers twice a day, however they may not need to be used every day due to the vagaries of the weather.

Currently a team of asparagus pickers will move through an asparagus field cutting the spears they determine to be of the required size and then placing the spears into a container.

The manual picking of asparagus is physically difficult as the pickers generally need to stoop to sever and collect each asparagus spear and this not only slows the whole process but can also cause repetitive strain injuries to occur to the pickers.

A further point to consider is that if the crop needs to be picked more than once a day, this can be difficult as often the asparagus pickers will pick the first crop at first light, (or shortly thereafter) and then will move onto another job.

Therefore if a second picking is required, it can be difficult to get enough pickers in order to do it correctly.

This will mean that the asparagus spears can grow beyond their optimum height and therefore will become downgraded and fetch a lower price.

Further aspects and advantages of the present invention will become apparent from the ensuing description which is given by way of example only.

### DISCLOSURE OF INVENTION

According to one aspect of the present invention there is provided a mechanical picker for use in collecting asparagus spears, including

a picking assembly, and

a picking assembly carriage,

characterised in that

Once the spear of asparagus has been selected to be picked the picking assembly carriage continues to move forward with respect to the ground and the picking assembly moves backwards with respect to the picking assembly carriage so as to stay in a virtually static position during the picking operation with respect to the spear of asparagus that has been selected to be picked.

It should be appreciated that throughout the present specification the driverate of the picking assembly with respect to the picking assembly carriage during the picking operation is substantially equal and opposite in direction to the driverate of the picking assembly carriage over the ground.

It should be appreciated that throughout the present specification the term “asparagus spear” should be understood to relate to the fresh stem of asparagus that has broken through the surface of the ground and has yet to have “leaf break”.

Throughout this present specification the term “picking assembly” should be understood to mean the portion of the present invention that enacts the gripping and severing of the asparagus spears.

It should also be appreciated that the term “picking assembly carriage” should be understood to mean the portion of the present invention to which the picking assembly is attached and which is either connected to a host vehicle in order to be towed or provides independent locomotion for the present invention and transfers this to the ground.

The mechanical picker preferably includes as part of the picking assembly

an asparagus gripping assembly, and

an asparagus severing assembly, and

an assembly for locating the horizontal position of an asparagus spear,

and be characterised in that

once a spear has been located by the horizontal position locating assembly, the picking assembly stays in a virtually static position with respect to the spear until after the spear has been severed from the plant.

The present invention also provides a picking assembly independent of the carriage.

It should be appreciated that throughout the present specification the term “an asparagus gripping assembly” should be understood to mean any apparatus that is capable of securely holding an asparagus spear, without damaging the asparagus spear, during the picking operation.

It should also be appreciated that the term “an asparagus severing assembly” should be understood throughout the present specification to mean any assembly capable of separating the asparagus spear from the parent plant.

Likewise, throughout the present specification the term “horizontal position locating assembly” should be understood to mean any means by which the horizontal position of the asparagus spear can be determined in order that the asparagus gripping and/or the asparagus severing assemblies can be correctly aligned with the asparagus spear.

According to a further aspect of the present invention there is provided a method of automatically picking asparagus spears by using a mechanical picker, which has a picking assembly carriage, and a picking assembly, including

an asparagus spear minimum height determining assembly, and

a horizontal position locating assembly; and

an asparagus gripping assembly, and

an asparagus severing assembly,

characterised by the steps of

a) moving the mechanical picker over a set of asparagus plants, and

b) determining, by use of the minimum height and distance determining assembly, when the mechanical picker is located above an asparagus spear with a height greater than the minimum height required, and

c) ensuring the picking assembly stays virtually static with respect to the asparagus spear whilst the picking assembly carriage continues to move over the set of asparagus plants, and

d) using the horizontal position locating assembly to locate the horizontal position of the asparagus spear with respect to the gripping and severing assemblies, and

e) moving the asparagus gripping assembly and the asparagus severing assembly with respect to the asparagus spear until they are in their optimum position for gripping and severing the asparagus spear, and

f) securing the asparagus spear in its' position by using the asparagus gripping assembly to grip the asparagus spear whilst the asparagus severing assembly severs the asparagus spear from the parent plant, and

g) moving the picking assembly forward along the picking assembly carriage until it either aligns with another spear that is required to be picked, or it returns to its primary position towards the front of the picking assembly carriage.

Throughout the present specification the term “horizontal position locating assembly” should be understood to mean any assembly that is capable of determining the azimuth position of an asparagus spear with respect to the asparagus gripping assembly or the asparagus severing assembly.

In preferred embodiments of the present invention the asparagus gripping assembly is constructed of two forward pointing tines fitted with an integral inflatable bladder which inflates to secure an asparagus spear when the spear is in the correct position between the tines.

However, this should not be seen to be a limitation upon the present invention in any way as in other embodiments of the present invention the asparagus gripping assembly can be any device capable of securing an asparagus spear without causing damage to the spear.

Examples of this could be foam-lined closing jaws, or systems such as those developed within modem robotics where the amount of pressure is measured by a gripping assembly in order to determine when it is being held securely.

Also in preferred embodiments of the present invention the asparagus severing assembly consists of a pneumatic knife that moves forward in such a way that it severs the fibrous asparagus spear at the required location on the spear, and then retracts into its initial position.

However, this also should not be seen to be a limitation on the present invention in any way as in other embodiments of the present invention the asparagus severing device may be any device capable of severing the spear from the parent plant.

Examples of this could be items such as spinning discs or a wire, which could be used to cut the stalk, or more “high-tech” methods such as using a pulsed laser or other energy-discharge devices.

It should be further understood that within preferred embodiments of the present invention the horizontal position locating assembly consists of two parts,

a) The main horizontal position locating assembly is constructed as part of the minimum height determining assembly,

b) The fine-tuning of the horizontal position locating achieved by a v-shaped pair of tines joined at their intersection to a position sensing device consisting of a number of sensors which determine whether or not the asparagus spear located between the tines is to the right or the left of the centre line and it also detects when the asparagus spear is in the correct position to be cut.

It should be appreciated however that this should not be seen to be a limitation on the present invention in any way as in other embodiments of the present invention the horizontal position locating assembly can be any assembly capable of determining the horizontal position of the asparagus spear with respect to the asparagus severing assembly.

Examples of this could be systems using soundwaves or light beams to determine the spear's location.

It can be appreciated that the height of the spear can be determined by a number of methods, particularly with the variety of sensor systems available today, however within preferred embodiments of the present invention a laser assembly is fitted to the picking assembly carriage, preferably at or close to the front of the carriage, in order to determine whether or not a spear passing under the carriage is of an adequate height to be picked.

Once the laser has determined that a spear of the correct height has been located the horizontal position locating assembly will determine the correct azimuth position of the spear with respect to the asparagus gripping assembly. The asparagus gripping assembly will then move until it is in the correct azimuth alignment with the spear and will inflate in order to hold the spear in the correct position. The asparagus severing assembly and its guide will then move down the spear until the blade of the severing assembly is at the correct cutting position and the cutting assembly will then sever the spear.

In preferred embodiments of the present specification the correct cutting position with respect to the ground is determined by a proximity sensor however it is appreciated that in other embodiments any other system capable of determining the severing assemblies vertical position with respect to the ground can be used.

It can be seen that the present invention has several distinct advantages over the current method of picking asparagus spears.

Currently all asparagus spears are picked manually and this is very expensive due to the high labour entailed by the process.

One significant advantage of the present invention is that once its initial cost has been recouped it will be very economical to use with respect to manual labour.

A major advantage of the present invention is that unless it is out of service it will always be available for picking the crop at any time of the day.

A further advantage of the present invention over manual picking of asparagus is that due to it having a minimum height sensor you can be assured that only asparagus spears of an adequate height will be picked.

Another very significant advantage of the present invention is that due to the unique picking assembly and picking assembly carriage construction, the asparagus picker does not need to stop during its operation as the picking assembly carriage continues at a steady pace throughout the operation of the invention, whilst the picking assembly moves with respect to the carriage during the picking action.

### BRIEF DESCRIPTION OF DRAWINGS

Further aspects of the present invention will become apparent from the following description which is given by way of example only and with reference to the accompanying drawings in which:

FIG. 1 is a diagrammatical representation of one preferred embodiment of the present invention. Control and power assemblies have been omitted in order to improve the clarity of the drawing.

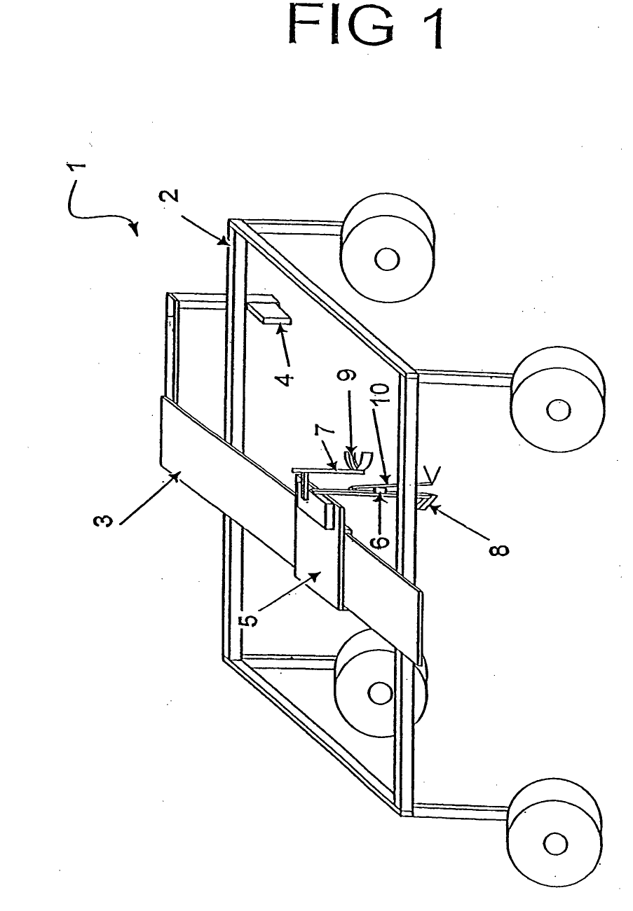

### BEST MODES FOR CARRYING OUT THE INVENTION

With reference to the figure there is illustrated a mechanical asparagus picker generally indicated by arrow 1.

The mechanical asparagus picker 1 consists of a picking assembly carriage 2 to which is fitted the picking assembly 3.

During operation of the mechanical asparagus picker 1, the picking assembly carriage 2 moves along a row, or set of, asparagus plants (not illustrated) and the picking assembly 3 can move forwards or backwards along the picking assembly carriage 2 as is required during the picking operation.

The spears of asparagus to be picked are determined by the minimum height and distance determining assembly 4 which is mounted onto the picking assembly 3 and can determine when a spear of asparagus is taller than a predetermined limit.

The minimum height and distance determining assembly 4 also determines the transverse position of the spear of asparagus from the minimum height and distance determining assembly 4.

Once the minimum height and distance determining assembly 4 has identified a spear of asparagus that is required to be picked, the horizontal positioning assembly 5 will move transversely across the picking assembly 3, to the position indicated by the minimum height and distance determining assembly 4, in order that it is located behind the spear to be picked.

The picking assembly 3 will continue to move forwards and the fine-tuning assembly 10 plus the severing assembly 8 will move downwards along the spear of asparagus until the correct distance from the ground for severing the spear of asparagus is reached.

If the spear of asparagus contacts one of the sides of the horizontal position fine-tuning assembly 10 one or more of the micro-switches 6 will be activated to inform the control circuit (not illustrated) as to whether the spear of asparagus is to the left or to the right of the gripping assembly 7 and the severing assembly 8.

The horizontal positioning assembly 5 will move transversely in the direction indicated by the micro-switch 6 until the micro-switch 6 is no longer activated—indicating that the spear of asparagus is correctly aligned with the severing assembly 8.

When the spear of asparagus is correctly aligned and when the picking assembly 3 has moved forward far enough onto the spear of asparagus, another micro-switch 6 is activated which drives the picking assembly 3 backwards with respect to the picking assembly carriage 2 at a rate which ensures that the picking assembly 3 stays virtually static with respect to the spear of asparagus until after the severing action has been completed.

Once this micro-switch has been closed the gripping assembly 7 will inflate its bladder 9 in order to safely secure the spear of asparagus in the correct position prior to the lowering of the severing assembly.

After the bladder 9 has been inflated the severing assembly 8 and the horizontal positioning assembly 5 will move vertically downwards until they are at the correct height from the ground so that the severing assembly 8 can fire the blade forward in order to sever the spear of asparagus from the parent plant before returning the blade to its secure position within the severing assembly 8.

The correct determination of the height of the severing assembly 8 above the ground is done by a proximity detector. This detector is not shown to improve the clarity of the drawing.

Once the spear has been successfully severed from the parent plant, it will be deposited into a container (not shown for clarity) or dropped to the ground, whichever is required. This is achieved by the deflation of the bladder 9 contained within the gripping assembly 7.

The picking assembly 3 will then move forward along the picking assembly carriage 2 until the picking assembly either reaches it forward-most position on the picking assembly carriage 2 or the minimum height and distance determining assembly 4 determines there is another spear which needs to be picked.

Aspects of the present invention have been described by way of example only and it should be appreciated that modifications and additions may be made thereto without departing from the scope of the appended claims.

1. A mechanical picker for use in collecting asparagus spears, including
a picking assembly, and
a picking assembly carriage,
characterised in that
Once the spear of asparagus has been selected to be picked, the picking assembly carriage continues to move forward with respect to the ground and the picking assembly moves backwards with respect to the picking assembly carriage so as to stay in a virtually static position during the picking operation with respect to the spear of asparagus that has been selected to be picked.

2. A mechanical picker as claimed in claim 1 wherein the picking assembly carriage is towed by a host vehicle.

3. A mechanical picker as claimed in claim 1 wherein the picking assembly carriage provides independent locomotion with respect to the ground.

4. A mechanical picker as claimed in any one of claim 1, wherein the picking assembly includes
an asparagus gripping assembly, and
an asparagus severing assembly, and
a horizontal position locating assembly,
characterised in that
once a spear has been located by the horizontal position locating assembly, the picking assembly stays in a virtually static position with respect to the spear until after the spear has been severed from the plant.

5. A mechanical picker as claimed in claim 4 wherein the asparagus gripping assembly is constructed of two forward pointing tines fitted with an integral inflatable bladder that inflates to secure an asparagus spear when the spear is in the correct position between the tines.

6. A mechanical picker as claimed in claim 4 wherein the asparagus severing assembly is constructed using a knife that can move forward in such a manner that it severs the asparagus spear at the required location on the spear and then retracts into its initial position.

7. A mechanical picker as claimed in claim 4 including
a minimum height determining assembly
characterised in that
the minimum height determining assembly ascertains whether or not the asparagus spear beneath the mechanical picker is of a height greater than the minimum height required.

8. A mechanical picker as claimed in claim 7 wherein the horizontal position locating assembly is constructed of two parts,
a) the main horizontal position locating assembly is constructed as part of the minimum height determining assembly, and
b) the fine tuning of the horizontal position locating is achieved by using a V-shaped pair of tines joined at their intersection to a position sensing device consisting of a number of sensors which determine whether or not the asparagus spear located between the tines is to the right, or to the left, of the centreline and the position sensing device can also detect when the asparagus spear is in the correct position to be cut.

9. A mechanical picker as claimed in claim 4 wherein the required position of the asparagus severing assembly is determined by a proximity sensor that determines vertical position of the severing assembly with respect to the ground.

10. A mechanical picker as claimed in claim 9 wherein the proximity sensor is an integral part of the asparagus severing assembly.

11. A method of automatically picking asparagus spears by using a mechanical picker, which has a picking assembly carriage and a picking assembly, including
an asparagus spear minimum height determining assembly, and
a horizontal position locating assembly, and
an asparagus gripping assembly, and
an asparagus severing assembly,
characterised by the steps of
a) moving the mechanical picker over a set of asparagus plants, and
b) determining, by use of the minimum height determining assembly, when the mechanical picker is located above an asparagus spear with a height greater than the minimum height required, and
c) ensuring the picking assembly stays virtually static with respect to the asparagus spear whilst the picking assembly carriage continues to move over the set of asparagus plants, and
d) using the horizontal position locating assembly to locate the horizontal position of the asparagus spear with respect to the gripping and severing assemblies, and
e) moving the asparagus gripping assembly and the asparagus severing assembly with respect to the asparagus spear until they are in their optimum position for gripping and severing the asparagus spear, and
f) securing the asparagus spear in its' position by using the asparagus gripping assembly to grip the asparagus spear whilst the asparagus severing assembly severs the asparagus spear from the parent plant, and
g) moving the picking assembly forward along the picking assembly carriage until it either aligns with another spear that is required to be picked or it returns to its primary position towards the front of the picking assembly carriage.

12. A method of automatically picking asparagus spears by using a mechanical asparagus picker as claimed in claim 7, wherein the asparagus spear minimum height determining assembly includes a laser assembly that is fitted close to the front of the picking assembly carriage.
